(19) United States
(12) Patent Application Publication
(10) Pub. No.: US 2022/0011470 A1
(43) Pub. Date: Jan. 13, 2022

(54) OPTIC PIECES HAVING INTEGRATED LENS ARRAYS

(71) Applicants: Anders Grunnet-Jepsen, San Jose, CA (US); Akihiro Takagi, San Mateo, CA (US); Paul Winer, Richmond, CA (US); John Sweetser, Sunnyvale, CA (US)

(72) Inventors: Anders Grunnet-Jepsen, San Jose, CA (US); Akihiro Takagi, San Mateo, CA (US); Paul Winer, Richmond, CA (US); John Sweetser, Sunnyvale, CA (US)

(21) Appl. No.: 17/483,324

(22) Filed: Sep. 23, 2021

(51) Int. Cl. G02B 3/00; G02B 1/04; G01B 11/22

(52) U.S. Cl. CPC G02B 3/0068; G01B 11/22; G02B 1/041

(57) ABSTRACT

Optic pieces having multiple lens arrays are disclosed. A disclosed example optic piece for use within a projection system includes a body extending between a first side of the body and a second side of the body that is opposite the first side, the body at least partially transparent, a first array of lenses on the first side of the body, ones of the first array of lenses having a respective first surface area, and a second array of lenses on the second side of the body, ones of the second lenses having a respective second surface area that is larger than the first surface area.

### FIELD OF I HE DISCLOSURE

This disclosure relates generally to three-dimensional (3D) imaging and, more particularly, to optic pieces having integrated lens arrays.

### BACKGROUND

Some 3-D imaging systems capture two images simultaneously via a right sensor (e.g., a right eye) and a left sensor (e.g., a left eye) that is linearly displaced from the right sensor to capture different views of a scene. To determine a depth at which objects in the scene are displaced, corresponding image points captured by the right and left sensors are identified to enable usage of triangulation.

### BRIEF DESCRIPTION OF THE DRAWINGS

FIG. 1 illustrates a known projection system.

FIG. 2 illustrates an example projection system in accordance with the teachings of this disclosure.

FIG. 3A illustrates a first side of an example optic piece of the example projection system of FIG. 2.

FIG. 3B illustrates an example implementation of a second side of the example optic piece of the example projection system of FIG. 2.

FIGS. 4A-C illustrate another example implementation of the second side of the example optic piece of the projection system of FIG. 2.

FIG. 5 is a detailed view of lenses on the first side of the example optic piece of the example projection system of FIG. 2.

FIGS. 6A-6E illustrate example lens shapes that can be implemented in examples disclosed herein.

FIGS. 7A-7E illustrate example energy distributions that can be produced by examples disclosed herein.

FIG. 8 illustrates an example pattern that can be produced by the example projection system of FIG. 2.

FIGS. 9A-11B illustrate differences in results between known systems and examples disclosed herein.

FIG. 12 is a flowchart representative of example machine readable instructions that may be executed by example processor circuitry to implement the example projection system of FIG. 2.

FIG. 13 is a flowchart representative of an example method to produce examples disclosed herein.

FIG. 14 is a block diagram of an example processing platform including processor circuitry structured to execute the example machine readable instructions of FIG. 12 to implement the example projection system of FIG. 2.

FIG. 15 is a block diagram of an example implementation of the processor circuitry of FIG. 14.

FIG. 16 is a block diagram of another example implementation of the processor circuitry of FIG. 14.

The figures are not to scale. In general, the same reference numbers will be used throughout the drawing(s) and accompanying written description to refer to the same or like parts. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a. different descriptor such as “second” or “third,” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors. Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever ones) of the multiple types of the processing circuitry is/are best suited to execute the computing task(s).

### DETAILED DESCRIPTION

Optic pieces having multiple lens arrays are disclosed. Systems, such as a computer vision stereo system, can extract three-dimensional (3-D) information from digital images using a first camera (e.g., a right camera) that obtains a first view of a scene and a second camera (e.g., a left camera) that obtains a second view of the scene from a different perspective. To obtain depth measurements, a pattern is projected onto a surface and captured by the first and second cameras. In turn, the pattern can be analyzed to determine depth measurements associated with locations in the scene. Specifically, corresponding image points between the first view and the second view are determined. As a result, triangulation can be utilized to measure a distance to respective points of the scene.

In some known implementations, to produce the pattern, a source projects an incident beam through a diffractive optical element, which disperses waves emitted by the incident beam. Typically, diffractive optical elements are implemented as a thin piece of glass with a polymer coating. In response to passing through the diffractive optical element, the dispersed waves encounter constructive and destructive interference which, in turn, enables the dispersed waves to add and subtract from one another and, as a result, a pattern of spats is formed on a surface of a scene.

In these known implementations, the diffractive optical element relies on a coherence of the waves passing therethrough to produce the pattern. However, an angular displacement of the diffractive optical element relative to source can be critical to enable the waves from the source to be coherent when encountered by the diffractive optical element. That is, a slight deviation in the angular displacement of the diffractive optical element can affect the coherence of the waves and, in turn, adversely affect the pattern produced by the waves passing through the diffractive optical element.

Moreover, the coherence of the waves can cause the waves to reflect off of a surface of the scene, which results in a phenomena called laser speckle. Specifically, the laser speckle causes the spots to blend together and vary in intensity, thereby resulting in spatial and temporal depth noise. Additionally, the intensity of the spot can be viewpoint dependent due to the aforementioned laser speckle. As such, when the cameras capture respective images of the pattern, the blending of the spots and the varying intensities captured from the different viewpoints of the cameras can cause the determined location of the spot in the scene to be inaccurate, which, in turn, can negatively affect depth measurements of the scene obtained through triangulation computations.

Additionally, diffraction is wavelength dependent. For instance, a decrease in the wavelength emitted from the source can reduce a separation between the spots in the pattern projected on the surface. Wavelengths can vary in an environment based on factors, such as temperature and humidity, and, thus, the pattern produced by the diffractive optical element can be inconsistent under different conditions.

Example optical elements disclosed herein utilize refraction to produce temporally and spatially stable patterns while being effective under a wide variety of environmental conditions. Example optical elements disclosed herein are achromatic, which enables the optical elements to form consistent patterns that are generally independent of a wavelength of a beam(s) passing therethrough. As such, example optical elements disclosed herein can maintain a stability of the projected pattern with various sources, various displacements (e.g., linear displacement, angular displacement, etc.) of the sources relative to the optical element. Example optical elements disclosed herein can withstand a wide variety of environmental conditions (e.g., temperature, humidity, etc.). As a result, the example optical elements disclosed herein increase manufacturing and/or assembly tolerance ranges associated with a position of the optical element relative to a light source in a projection system, such as stereo vision systems in smartphones, laptops, robots, etc.

Example optical elements disclosed herein include a body that is at least partially transparent and extends longitudinally between a first side and a second side opposite the first side. According to examples disclosed herein, the body can be at least partially composed of a plastic material, such as polycarbonate. In some examples, the, body is glass or any other appropriate transparent or semitransparent material. The example body can be formed via molding, 3-D printing, electroforming, and/or diamond turning.

The example optical elements disclosed herein include a first array of lenses (e.g., microlenses) on the first side of the body. In some examples disclosed herein, ones of the lenses of the first array are contiguous. Further, the first lenses are protrusions that protrude in a direction away from the second side of the body.

Further, the example optical element includes a second array of lenses on the second side of the body. In some examples, ones of the lenses of the second array are contiguous. According to examples disclosed herein, the second lenses have larger surface areas than the first lenses. Specifically, ones of the lenses of the second array can have surface areas of approximately 0.5-1.0 square millimeter (mm²) and ones of the lenses of the first array can have surface areas less than 0.5 mm², for example.

The example optical elements disclosed herein project a light pattern in response to receiving light from at least one light source (e.g., one or more virtual cavity surface emitting lasers (VCSELs), one or more light emitting diodes (LEDs), etc). For example, the light source can emit light having a wavelength within the visible light spectrum or within the invisible light spectrum. Further, the light source emits light onto at least a portion of the lenses of the first array, which produce the light pattern. Specifically, the light pattern is produced based on a grid defined by the lenses of the first array that receive light from the light source. Further, ones of the lenses of the second array project the light pattern onto an area of a scene. In some examples, the example optical elements disclosed herein can project the same light pattern onto the area of the scene in response to the one or more light sources emitting a first wavelength or a second wavelength.

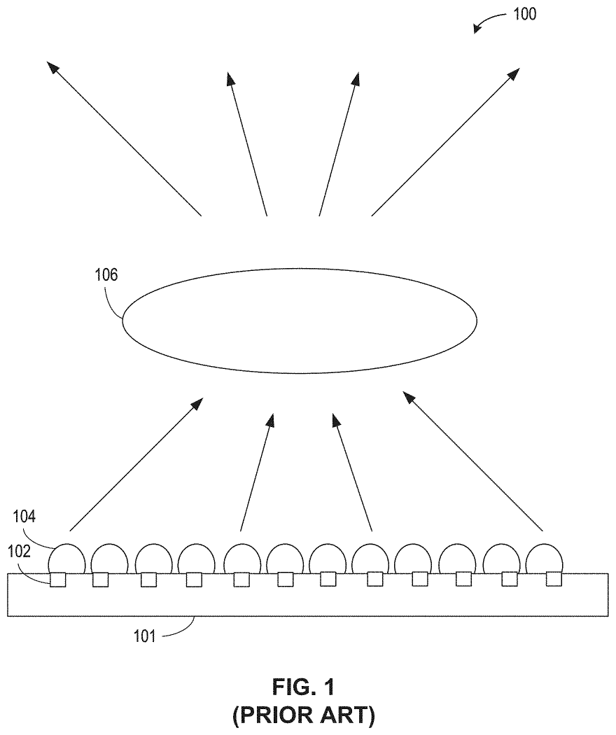

FIG. 1 illustrates a known projection system 100. In FIG. 1, the projection system 100 includes a die 101 of VCSELs 102, microlenses 104, and projection lens 106 separate from the microlenses 104. The VCSELs 102 emit light through respective ones of the microlenses 104, which project a pattern towards the projection lens 106, In turn, the projection lens 106 projects the pattern onto a surface of a scene. Accordingly, cameras can capture images of the scene and the pattern can be analyzed to determine depth measurements of surfaces that receive the pattern.

In FIG. 1, respective ones of the microlenses 104 align with respective ones of the VCSELs 102. To direct light from the VCSELs 102 along a periphery of die 101 toward the projection lens 106, outer portions of the microlenses 104 positioned along the periphery of the die 101 are aligned with the respective ones of the VCSELs 102. As such, a horizontal alignment of the microlenses 104 has a minimal tolerance range, which can increase costs associated with manufacturing and assembly of the known projection system 100.

In this known system, the microlenses 104 are positioned within 10 micrometers of the VCSELs 102 to enable the respective ones of the microlenses 104 to capture a field of view of the light (e.g., a full width half maximum (FWHM)) projected by the respective ones of the VCSELs 102. Accordingly, a vertical alignment of the microlenses 104 relative to the VCSELs 102 has a minimal tolerance range. Moreover, an angular displacement of the microlenses 104 relative to the VCSELs 102 is within a similarly tight tolerance range to prevent light from the VCSELs 102 from not being captured by the microlenses 104 and to enable the projection lens 106 to capture the light projected by the microlenses 104. As such, the projection system 100 includes multiple alignment dimensions that must be held within tight tolerance ranges, thereby increasing costs associated with manufacturing and assembly thereof.

A quantity of spots in the pattern projected by the known projection system 100 is based on a quantity of VCSELs 102 in the die 101. In general, projection patterns utilize more than 10,000 spots. Thus, the projection system 100 necessitates that the die 101 be large enough to include more than 10,000 VCSELs 102 to obtain a desired quantity of spots in the projected pattern. As such, the large die can increase a size and a cost of these known implementations. Moreover, the spots can encounter laser speckle as each individual spot results from respective ones of the VCSELs 102, which are coherent. As such, there may be differences in the projected pattern captured by cameras from different viewpoints, which may result in errors in the depth measurement computed for known systems.

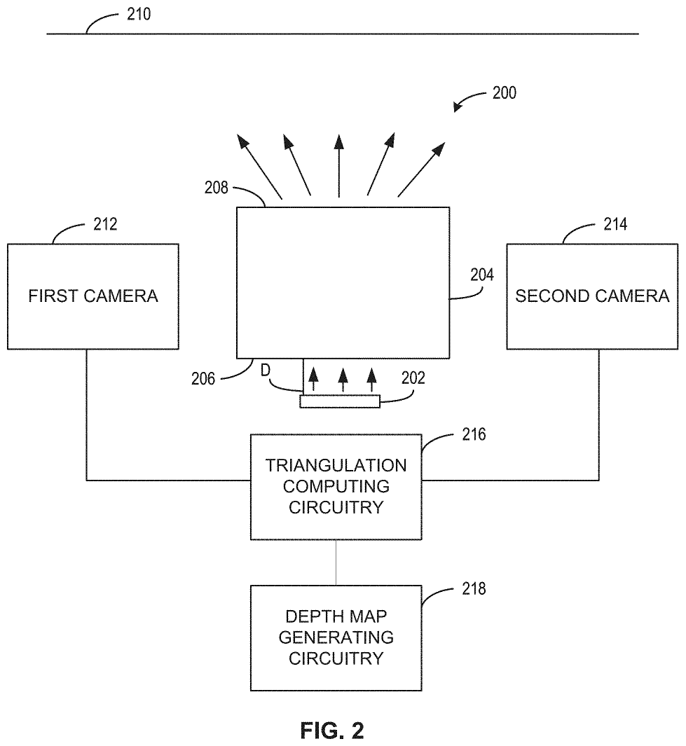

FIG. 2 illustrates an example projection system 200 in accordance with the teachings of this disclosure. in the illustrated example of FIG. 2, the projection system 200 includes at least one light source 202 at least one light emitter) and an optic piece 204. The example optic piece 204 is at least partially composed of a transparent plastic material. such as polycarbonate. However, any appropriate material can be implemented instead. For example, the optic piece 204 can include glass or any other transparent material. The optic piece 204 of the illustrated example can he formed via molding, three dimensional printing, electroforming, and/or diamond turning.

In the illustrated example of FIG. 2, the light source(s) 202 can include an array of VCSELs. In this example, the optic piece 204 is achromatic and, thus, a pattern projected by the optic piece 204 can be maintained even under varying wavelengths of light projected by the light source(s) 202. Accordingly, the light source(s) 202 can emit red light, green light, blue light, infrared light, and/or light having other wavelengths in the visible spectrum or the invisible spectrum. However, any other appropriate wavelength(s) can be implemented instead.

In the illustrated example of FIG. 2, a first side 206 of the optic piece 204 receives the light emitted by the light source(s) 202. Specifically, a first array of lenses is positioned on the first side 206 of the optic piece 204, as discussed in further detail below. The first array of lenses produces a pattern in response to receiving the light from the light source(s) 202. In this example, the first side 206 of the optic piece 204 is separated from the light source(s) 202 by a distance, D. According to some examples, the separation distance, D, between the light source(s) 202 and the optic piece 204 causes the light source(s) 202 to emit light onto a portion of the lenses (i.e., not all of the lenses) in the first array. In other words, in such examples, only some of the lenses in the first array are exposed to the light based on the distance, D, being below a threshold distance.

In some examples, the separation distance, D, is increased to cause the light source(s) 202 to emit light onto a larger portion of the lenses in the first array, which increases a size of the pattern produced by the lenses of the first array. in some examples, the separation distance, D, is decreased to cause the light source(s) 202 to emit light onto a smaller number of the lenses in the first array, which decreases a size of the pattern produced by the lenses. As such, the size of the pattern produced by the projection system 200 can be adjusted to fit a field of view of cameras for capturing the pattern. As a result, the projection system 200 can reduce wasted energy (e.g., energy used to produce adequate light) by preventing the pattern from being projected outside the view of the cameras and, in turn, enables a brightness of the pattern to be increased (e.g., maximized) for the corresponding field of view. Accordingly, enabling the optical piece 204 to project the pattern with various separation distances from the light source(s) 202 increases a tolerance range of the separation distance, D, and, in turn, reduces costs associated with manufacturing and/or assembling the projection system 200. In some examples, the separation distance, D, is greater than 10 micrometers.

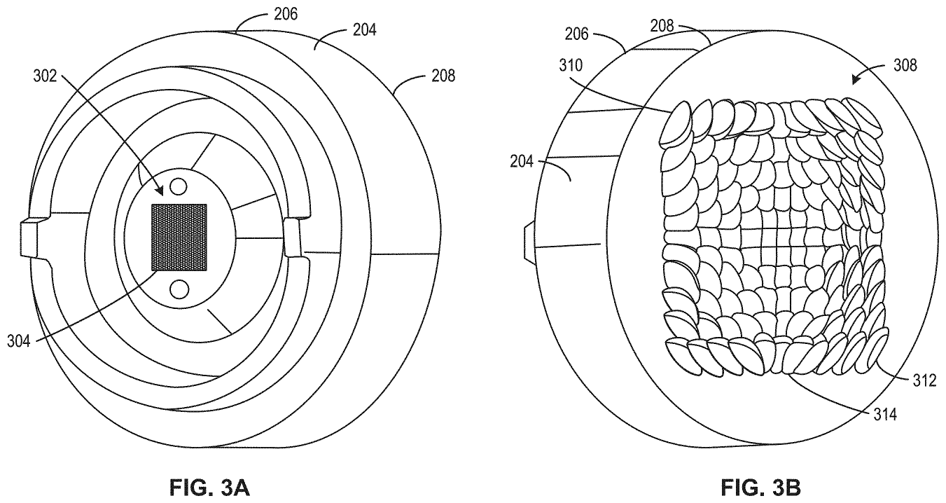

In this example, the example optic piece 204 extends longitudinally between the first side 206 and a second side 208 opposite the first side 206. Accordingly, light emitted by the light source(s) 202 enters the first side 206 of the optic piece 204 and projects out the second side 208. In particular, the second side 208 of the optic piece 204 projects a pattern onto a surface(s) 210 of a scene. In this example, a second array of lenses includes lenses having larger surface areas than the lenses in the first array is positioned on the second side 208 of the optic piece 204 to project the pattern. In some examples, the pattern corresponds to a shape of the lenses of the first array and/or an arrangement of the lenses in the first array, as discussed in further detail below in connection with FIGS. 3A-B. In some examples, in response to the light source(s) 202 including an array of VCSELs, respective ones of the lenses in the first array receive light from more than one VCSEL in the array, which reduces a coherence of the light received by the lenses in the first array and, in turn, reduces a laser speckle in the pattern projected by the optic piece 204.

In the illustrated example of FIG. 2, the projection system 200 includes a first camera 212 and a second camera 214 to capture images or videos of the surface(s) 210 in the scene in response to the second side 208 of the optic piece 204 projecting the pattern onto the surface(s) 210. In some examples, the first camera 212 is displaced horizontally from the second camera 214 (in the view of FIG. 2). As such, the first camera 212 captures a first viewpoint of the surface(s) 210 and the second cam era 214 captures a second viewpoint of the surface(s) 210.

In the illustrated example of FIG. 2, the projection system 200 includes triangulation computing circuitry 216 and depth map generating circuitry 218. In this example, the triangulation computing circuitry 216 identifies corresponding image points on the surface(s) 210 in the images captured by the first camera 212 and the second camera 214. In turn, the triangulation computing circuitry 216 can determine depth measurements of points on the surface(s) 210 based on a location of the image points and the position of the cameras 212, 214. Further, the depth map generating circuitry 218 can generate a depth map of the surface(s) 210 of the scene based on the depth measurements of the points on the surface(s) 210.

FIG. 3A illustrates an example implementation of the first side 206 of the example optic piece 204 of FIG. 2. In FIG. 3A, the first side 206 includes a first array of lenses 302 which, in turn, includes a plurality of lenses 304, In FIG. 3A, adjacent ones of the lenses 304 share borders to eliminate or otherwise reduce gaps between the lenses 304 and, thus, increase a percentage of the light emitted by the light source(s) 202 and received by the lenses 304. In FIG. 3A, the lenses 304 are virtual emitters that emit light through the second side 208 of the optic piece 204 after receiving light from the light source(s) 202.

According to the illustrated example, the lenses 304 are microlenses having a diameter between approximately 0.01-0.5 mm. in this example, the lenses 304 are protrusions in the first side 206 that protrude in a direction away from the second side 208 of the optic piece 204. In some examples, the first array 302 includes a uniform grid pattern or arrangement of the lenses 304. Alternatively, in some examples, the first array 302 includes a semirandom grid pattern or arrangement of the lenses 304.

In this example, ones of the lenses 304 in the first array 302 receive the light emitted by the light source(s) 202 (shown FIG. 2), In some examples, ones of the lenses 304 receive light from more than one light source to reduce a coherence of the light received. For example, the light source(s) 202 can include an array of VCSELs and respective ones of the first lenses 304 can receive light emitted by more than one VCSEL in the array of VCSELs. As previously mentioned above in connection with FIG. 2, the portion of the lenses 304 that receive light from the light source(s) 202 can be based on the separation distance, D, between the first side 206 of the optic piece 204 and the light source(s) 202.

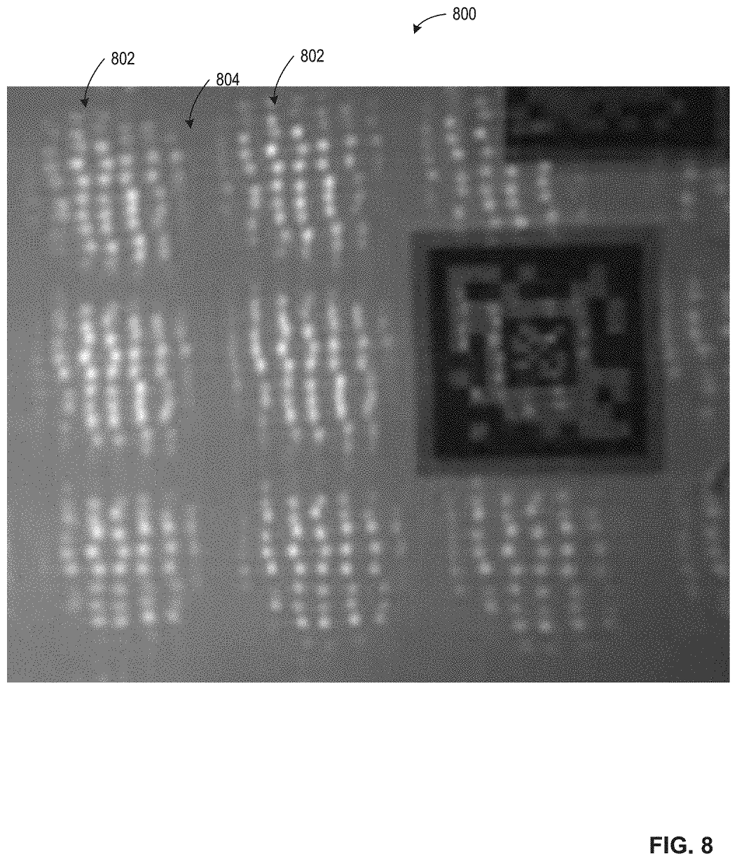

In the illustrated example, the lenses 304 produce a pattern. Specifically, the pattern produced by the lenses 304 corresponds to a layout or arrangement of the portion of the lenses 304 that is illuminated by the light source(s) 202. Accordingly, a size of the pattern can be based on the aforementioned separation distance, D, between the optic piece 204 and the light source(s) 202. In turn, respective ones of the lenses 304 bend or redirect the light towards respective lenses in a second array on the second side 208 of the optic piece 204 to relay the pattern to the respective lenses in the second array. In this example, the lenses in the second array duplicate the pattern and, in turn, project the duplicates of the pattern onto a surface of a scene, as discussed in further detail below in connection with FIG. 8.

FIG. 3B illustrates an example implementation of the second side 208 of the example optic piece 204 of FIG. 2. The illustrated example of FIG. 3B is also referred to as a “dragon's eye” implementation. In this example, the second side 208 includes a second array of lenses 308 which, in turn, includes lenses 310. Further, respective ones of the example lenses 310 project a pattern produced by the lenses 304 onto a surface(s) of a scene. As a result, the cameras 212, 214 (FIG. 2) can capture respective images of the patterns and, in turn, the captured patterns can be utilized by the triangulation computing circuitry 216 of FIG. 2 to compute respective depths associated with the surface(s) 210 in the scene.

In the illustrated example, ones of the lenses 310 on the second side 208 of the optic piece 204 have larger surface areas than ones of the lenses 304 on the first side 206. Accordingly, the second array of lenses 308 has a larger overall surface area or footprint than the first array of lenses 302. In this example, the surface area of the second array of lenses 308 determines an illumination size (e.g., a field of view (in degrees)) of the patterns projected by the optical piece 204.

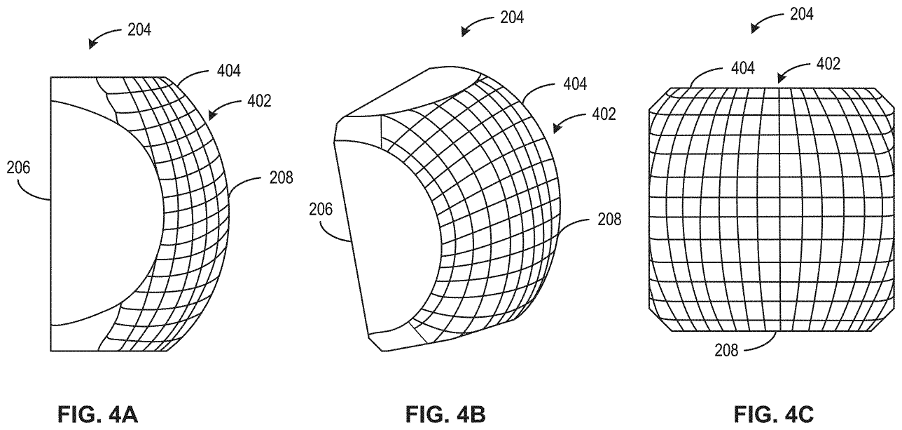

The second side 208 of the illustrated example is planar. In some other examples, the second side 208 is curved, as discussed in further detail below in connection with FIG. 4. Further, respective ones of the lenses 310 in the second array of lenses 308 include different focal lengths. For example, the second array of lenses 308 includes a first lens 312 having a first focal length and a second lens 314 having a second focal length different from the first focal length. Specifically, the different focal lengths enables focusing of the patterns produced by the lenses 304. Accordingly, the lenses 310 can project a plurality of the patterns onto the surface(s) 210 of a scene e preventing the focus of the pattern from being affected by a position of the respective one of the lenses 310 that projected the pattern.

In some examples, a size of the patterns projected by the lenses 310 and, thus, a spatial relationship (e.g., a separation between the patterns, an overlap of the patterns, etc.) between the respective patterns is based on the portion of the first array 302 illuminated by the light source(s) 202. For example, the respective patterns may be separated from one another in response to a first portion of the first array 302 being illuminated by the light source(s) 202. Further, the respective patterns may touch or overlap in response to a second portion of the first array 302 larger than the first portion being illuminated by the light source(s) 202.

FIGS. 4A-C illustrate another example implementation of the second side 208 of FIG. 2. The illustrated example of FIGS. 4A-4C can also be referred to as a “fly's eye” implementation. In FIGS. 4A-C, the second side 208 of the optic piece 204 includes an array of lenses 402, which includes lenses 404, According to the illustrated example, the second side 208 is generally curved such that the lenses 404 exhibit some degree of curvature and when a relatively large number of the lenses are placed adjacent to one another, the overall array of lenses 402 is curved. In some examples, ones of the lenses 404 include a same curvature a same focal length to focus the patterns produced by the first array of lenses 302 (FIG. 3A) on the first side 206 of the optic piece 204.

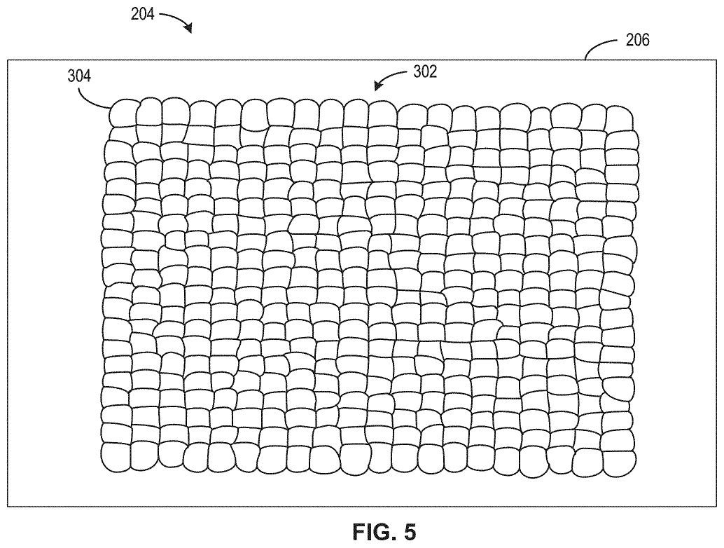

FIG. 5 is a detailed view of the lenses 304 on the first side 206 of the example optic piece 204. In FIG. 5, the array of lenses 302 includes the lenses 304 arranged in a semi-random grid (e.g., an asymmetrical layout). In some examples, the semi-random grid enables certain locations within the pattern to be identified by the triangulation computing circuitry 216 (FIG. 2) with greater accuracy. In some examples, the first array 302 positions the first lenses 304 in a uniform grid (e.g., a symmetrical layout).

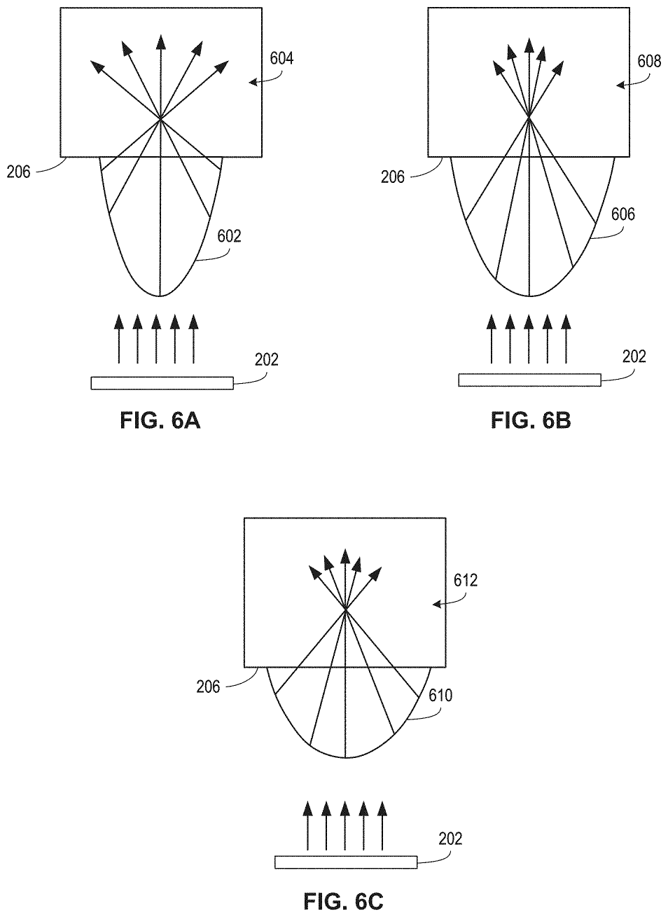

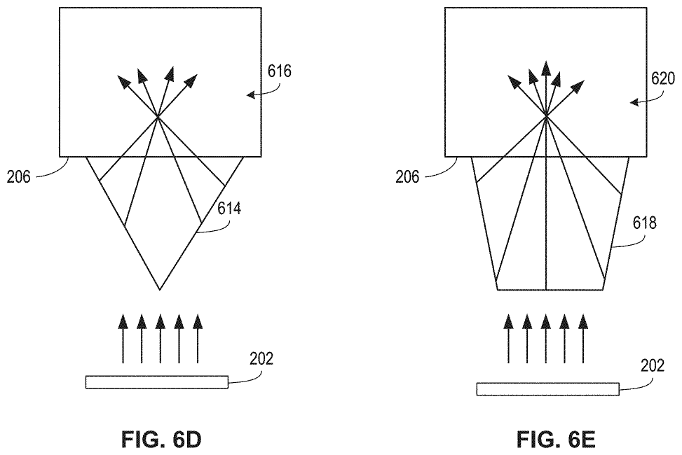

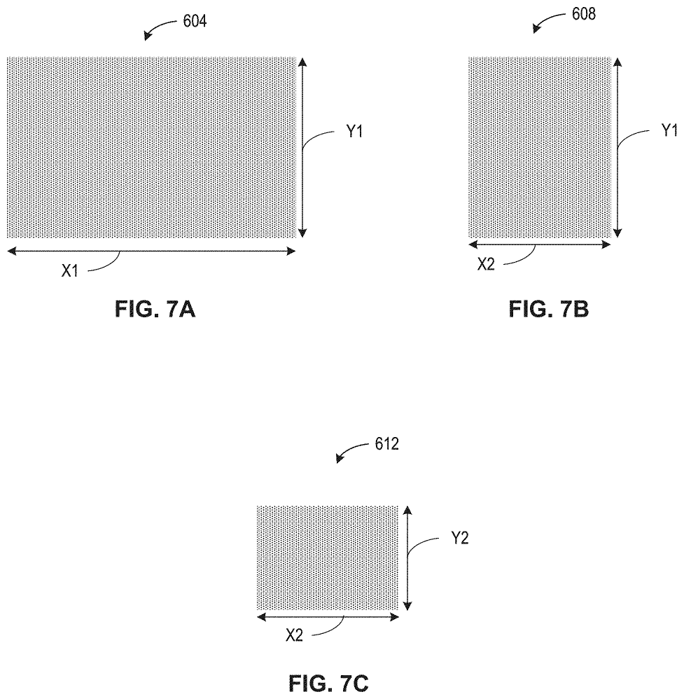

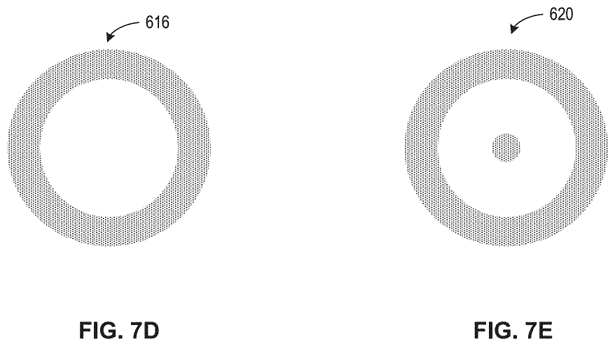

In the illustrated example of FIG. 5, the lenses 304 are generally shaped as individual semi-round protruding structures resembling bumps or grains on the first side 206 of the optic piece 204. In some examples. cross-sectional profiles of these semi-round protruding structures can be in the form of a parabolic curve, a higher degree polynomial curve, a hyperbolic curve, a semicircle, an asymmetric curve, a triangle, a trapezoid, or any other appropriate shape. A shape of the lenses 304 can determine an energy distribution in the pattern produced by the first array of lenses 302. That is, the shape of the lenses 304 shapes a field of view of a beam projected towards the second side 208 (FIG. 2) of the optic piece 204. For example, the shape of the lenses 304 can determine a shape of spots in the pattern and, thus, an energy distribution in the pattern, as discussed in further detail below in connection with FIGS. 6A-7E.

FIG. 6A illustrates an example cross-section of a first example microlens 602 that may be implemented in the first array of lenses 302 on the first side 206 of the optic piece 204. In this example, an overall shape of the microlens 602 is defined based on a higher degree polynomial curve. In this example, the microlens 602 receives light from the light source(s) 202. In this example, the microlens 602 redirects the light to produce a first energy distribution 604, as discussed further below in association with FIG. 7A.

FIG. 6B illustrates an example cross-section of a second example microlens 606 that may be implemented in the first array of lenses 302 on the first side 206 of the optic piece 204. In FIG. 6B, a shape of the microlens 606 is defined by a parabolic curve. Accordingly, the microlens 606 has a larger width than the first microlens 602. In this example, the microlens 606 receives light from the light source(s) 202 and redirects the light to produce a second energy distribution 608, as discussed further in association with FIG. 7B.

FIG. 6C illustrates an example cross-section of a third example microlens 610 that may be implemented in the first array of lenses 302 on the first side 206 of the optic piece 204. In FIG. 6C, the microlens 610 is generally shaped as a half sphere. Accordingly, the microlens 610 can have a same width as the aforementioned microlens 606 of FIG. 6B and a reduced height compared to the microlens 606, for example. In FIG. 6C, the microlens 610 receives light from the light source(s) 202 and redirects the light to produce a third energy distribution 612, as discussed further in association with FIG. 7C.

FIG. 6D illustrates an example cross-section of a fourth example microlens 614 that may be implemented on the first side 206 of the optic piece 204. In FIG. 6D, the microlens 614 is generally shaped as a cone. In FIG. 6D, the microlens 614 receives light from the light source(s) 202 and redirects the light to produce a fourth energy distribution 616, as discussed further in association with FIG. 7D.

FIG. 6E illustrates an example cross-section of a fifth example microlens 618 that may be implemented in the first array of lenses 302 on the first side 206 of the optic piece 204. In FIG. 6E, the microlens 618 is generally shaped as a trapezoidal prism. In FIG. 6E, the microlens 618 receives light from the light source(s) 202 and redirects the light to produce a fifth energy distribution 620, as discussed further in association with FIG. 7E.

In the illustrated example of FIG. 7A, the first microlens 602 of FIG. 6A causes the first energy distribution 604 to have a first range, X1, in a first dimension and a second range, Y1, in a second dimension. In this example, the microlens 602 projects the first energy distribution 604 towards the second side 208 of the optic piece 204. In some examples, the first energy distribution 604 is based on a size of the second array 308. That is, the example microlens 602 produces the first energy distribution 604 to match a size and shape of the second array 308 in response to the first energy distribution 604 reaching the second side 208 of the optic piece 204, for example.

In the, illustrated example of FIG. 7B, the second microlens 606 of FIG. 6B causes the second energy distribution 608 to have a third range, X2, in the first dimension that is less than the first range, X1. Specifically, the increased wideness of the microlens 606 of FIG. 6B compared to the microlens 602 of FIG. 6A causes the second energy distribution 608 to have the reduced range, X2, in the first dimension. Further, the second example microlens 606 causes the second energy distribution 708 to have the second range, Y1, in the second dimension. Accordingly, the microlens 606 may be utilized when the second array of lenses 308 has a reduced size in the first dimension.

In the illustrated example of FIG. 7C, the third microlens 610 causes the third energy distribution 612 to have the third range X2 in the first dimension. Further, the third example microlens 610 causes the third energy distribution to have a fourth range, Y2, in the second dimension that is smaller than the second range, Y1. Specifically, the reduced height of the microlens 610 of FIG. 6C compared to the microlens 606 of FIG. 6B causes the third energy distribution 612 to have the reduced range, Y2, in the second dimension. Accordingly, the microlens 610 may be utilized when the second array 308 of second lenses 310 has a reduced size in the first dimension, as well as the second dimension.

In the illustrated example of FIG. 7D, the fourth microlens 614 causes the fourth energy distribution 616 to have a ring-like shape. Accordingly, the example microlens 614 may be utilized when the second array of lenses 308 is defined by a ring that corresponds to the ring-like shape of the fourth energy distribution 616.

In the illustrated example of FIG. 7E, the fifth microlens 618 causes the fifth energy distribution 620 to resemble a ring-like shape surrounding a dot positioned in a central portion of the ring. Accordingly, the example microlens 618 may be utilized when the second array of lenses 308 is defined by a ring centrically positioned around an inner circle.

Although the illustrated example microlenses 602, 606, 610, 614, 618 of FIGS. 6A-E produce the example energy distributions of FIGS. 7A-7E, it should be understood that the lenses 304 in the first array of lenses 302 may be defined by any other shape to produce an energy distribution that snatches any geometric array of lenses on the second side 208 of the optic piece 204.

FIG. 8 illustrates a portion of an example projection 800 that can be produced by the optic piece 204, for example. In FIG. 8, the example projection 800 includes multiple ones of a pattern 802. In FIG. 8, the pattern 802 is defined by an arrangement of the lenses 304 in the first array 302 on the first side 206 of the optic piece 204. Specifically, the pattern 802 is defined by the portion of the first lenses 304 that are illuminated by the light source(s) 202. Further, respective ones of the pattern 802 are projected by the lenses 310 on the second side 208 of the optic piece 204.

In FIG. 8, the projection 800 includes a separation 804 between the respective ones of the pattern 802. In some examples, the separation 804 between the respective ones of the pattern 802 is based on the distance, D, between the light source(s) 202 and the optic piece 204. For example, the separation 804 may be increased in response to the distance, D, being reduced. Further, the separation may be decreased in response to an increase of the distance, D. In some examples, increasing the distance, D, causes the respective ones of the pattern 802 to touch or overlap.

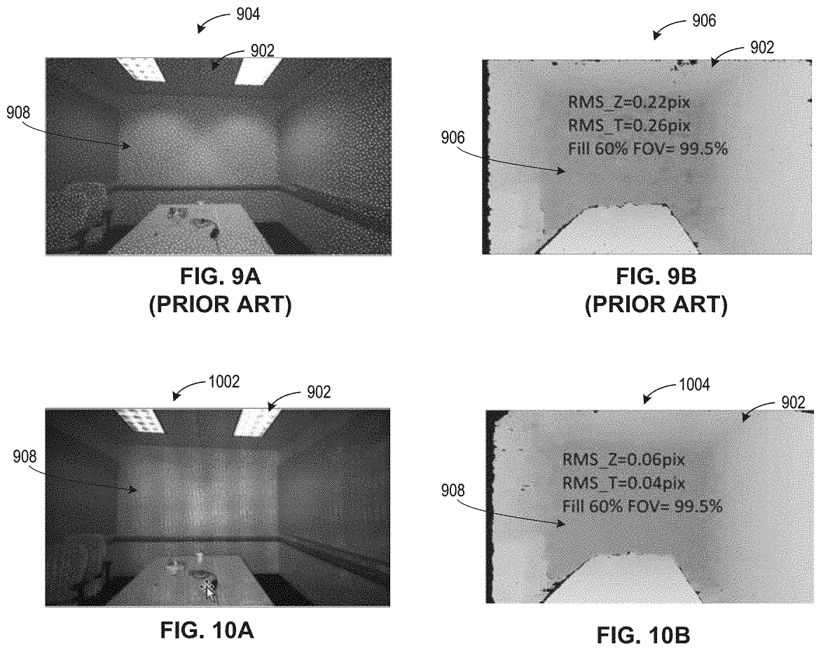

FIGS. 9A and 9B illustrate a first scene 902 including a first example projection 904 and a first example depth map 906 produced by known systems, Specifically, the first depth map 906 is computed based on the first projection 904 of FIG. 9A.

In FIG. 9B, the first depth map 906 includes a spatial noise (“RMS_Z”) having a standard deviation of 0.22. In turn, the first depth map 906 includes a temporal noise (“RMS_T”) having a standard deviation of 0.26. As such, the pattern projected by known systems deviates over space and time, which can cause inaccurate measurements in the first depth map 906. Specifically, known systems can measure a back wall 908 in the scene 902 with various depths at random locations, as demonstrated by a fuzziness that corresponds to the back wall 908 in the first depth map 906.

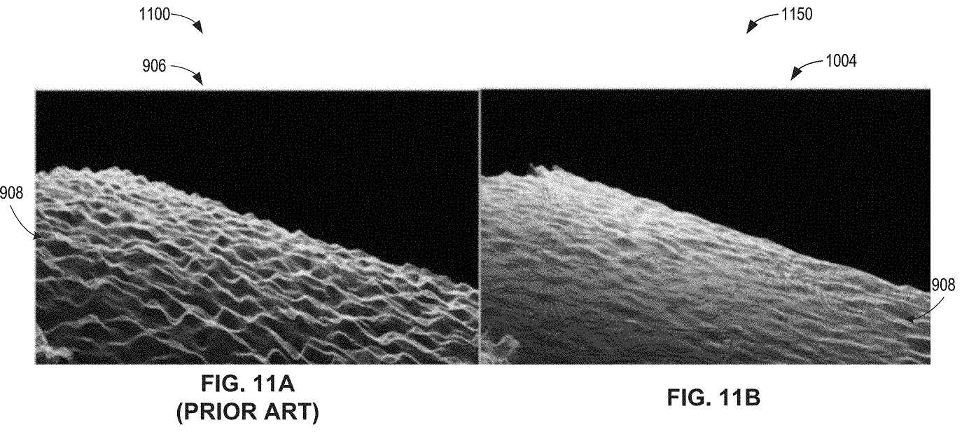

FIGS. 10A-B illustrates the first scene 902 including a second. example projection 1002 and a second example depth map 1004 of the first scene 902 that can be produced by examples disclosed herein. Specifically, the second depth map 1004 is computed based on the second projection of FIG. 10A.

In FIG. 10B, the second depth map 1004 includes a spatial noise having a standard deviation of 0.06. In the illustrated example of FIG. 10B, the second depth map 1004 includes a temporal noise having a standard deviation of 0.08. As such, the projection 1002 produced by the example projection system 200 has reduced deviation over space and time compared to the projection of FIG. 9B. Thus, the projection 1002 enables more accurate and consistent depth measurements to be obtained, as indicated by a smoothness of the back wall 908 in the second depth map 1004, in contrast to the fuzziness of the back wall 908 exhibited by the known systems.

FIG. 11A illustrates an example magnified view 1100 of the back wall 908 in the first depth map 906 obtained via the pattern projected by known systems. In FIG. 11A, a roughness of the back wall 908 results from the spatial noise in the first depth map 906. Additionally, the roughness in the back wall 908 changes over time as result of the temporal noise in the first depth map 906.

FIG. 11B illustrates a magnified view 1150 of the example back wall 908 in the second depth map 1004 obtained via the pattern projected by examples disclosed herein. In FIG. 11B, the waves of FIG. 11A are minimized or otherwise reduced as a result of the reduced spatial noise associated with the second depth map. Additionally. movement of the waves is minimized or otherwise reduced as a result of the reduced temporal noise associated with the second depth map 1004. Accordingly, the pattern projected by the projection system 200 improves an accuracy and a stability of the second depth map 1004.

In some examples, the projection system 200 includes means for emitting light. For example, the means for emitting may be implemented by light source(s) 202, In some examples, the light source(s) 202 may he implemented by a VCSEL, a LED, an array or VCSELs, or an array of LEDs. In some examples, the light source(s) 202 emit light having a wavelengths smaller than 1 mm.

In some examples, the projection system 200 includes means for refracting the light emitted by the means for emitting. For example, the means for refracting may be implemented by the example optic piece 204. In some examples, the optic piece 204 may be implemented by the first array of lenses 302 and the second array of lenses 308 illustrated in FIG. 3B or the second array of lenses 402 illustrated in FIGS. 4A-4C.

In some examples, the means for refracting includes means for producing a light pattern. For example, the means for producing may be implemented by the first array of lenses 302. In some examples, the first array of lenses 302 may be implemented by the first microlens 602, the second microlens 606, the third microlens 610, the fourth microlens 614, or the fifth microlens 618.

In some examples, the means for refracting includes means for projecting multiple ones of the light pattern. For example, the means for projecting may be implemented by the second array of lenses 308 illustrated in FIG. 3B or the second array of lenses 402 illustrated in FIGS. 4A-4C.

While an example manner of implementing the projection system 200 of FIG. 2 is illustrated in FIG. 2, one or more of the elements, processes, and/or devices illustrated in FIG. 4 may be combined, divided, re-arranged, omitted. eliminated, and/or implemented in any other way. Further, the example first camera 212, the example second camera 214, the example triangulation computing circuitry 216, and the example depth map generating circuitry 218, may be implemented by hardware, software, firmware, and/or any combination of hardware, software, and/or firmware. Thus, for example, any of the example first camera 212, the example second camera 214, the example triangulation computing circuitry 216, and the example depth map generating circuitry 218, and/or, more generally, the example projection system 200, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example first camera 212, the example second camera 214, the example triangulation computing circuitry 216, and the example depth map generating circuitry 218 is/are hereby expressly defined to include a non-transitory computer readable storage device or storage disk such as a memory, a digital versatile disk (DVD), a compact disk (CD), a Blu-ray disk, etc., including the software and/or firmware. Further still, the example projection system 200 of FIG. 2 may include one or more elements, processes, and/or devices in addition to, or instead of, those illustrated in FIG. 2, and/or may include more than one of any or all of the illustrated elements, processes and devices.

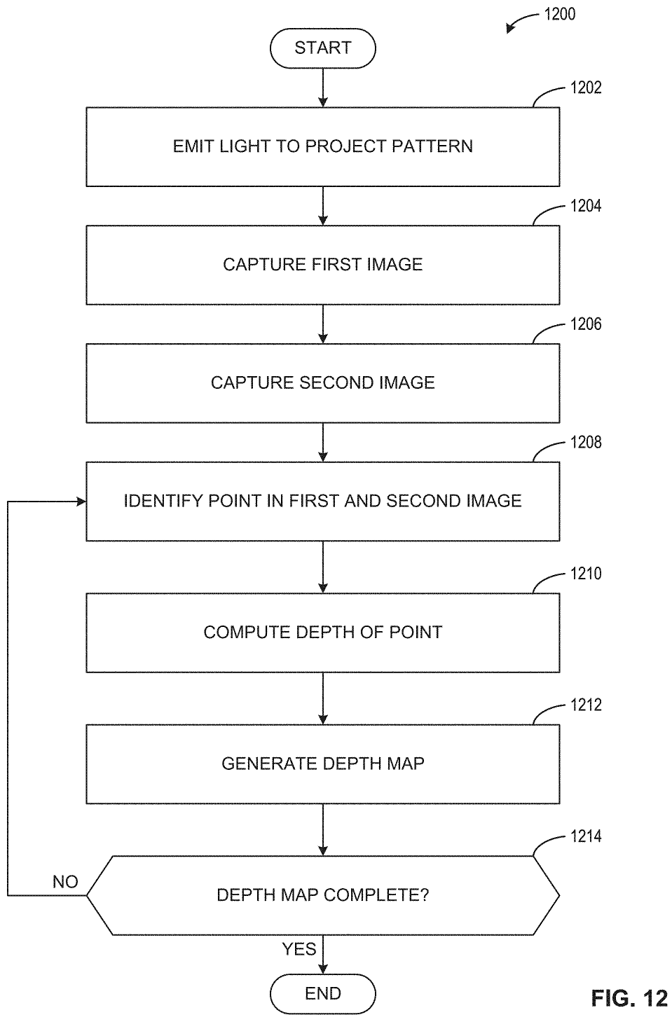

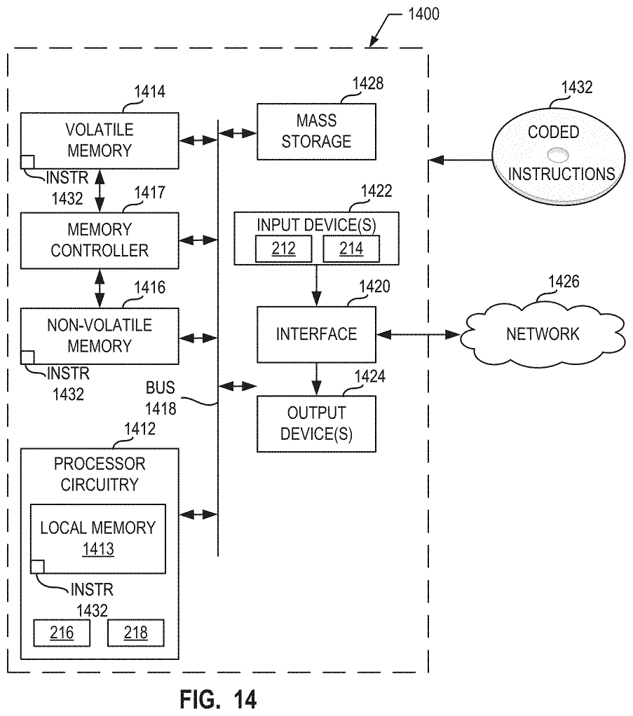

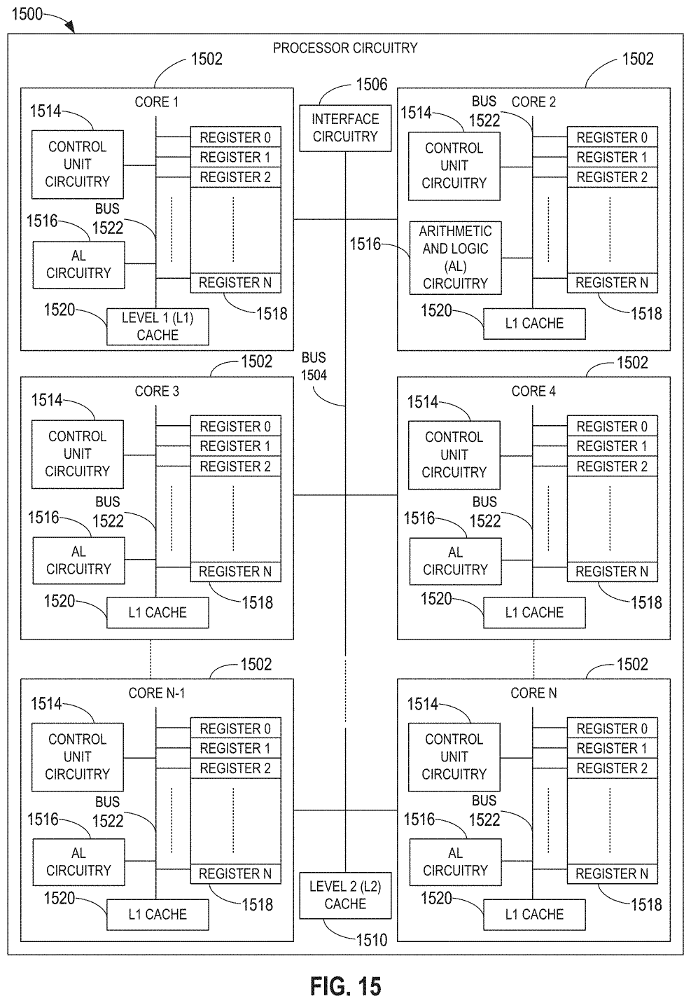

A flowchart representative of example hardware logic circuitry, machine readable instructions, hardware implemented state machines, and/or any combination thereof for implementing the projection system 200 is shown in FIG. 12. The machine readable instructions may be one or more executable programs or portion(s) of an executable program for execution by processor circuitry, such as the processor circuitry 1412 shown in the example processor platform 1400 discussed below in connection with FIG. 14 and/or the example processor circuitry discussed below in connection with FIGS. 15 and/or 16. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices a (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 12, many other methods of implementing the example projection system 200 may alternatively be used. For example, the order of execution of the blocks may be changed, and/or some of the blocks described may be changed, eliminated, or combined. Additionally or alternatively, any or all of the blocks may he implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to snake them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 12 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone. (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 12 is a flowchart representative of example machine readable instructions and/or example operations 1200 that may be executed and/or instantiated by processor circuitry to implement the projection system 200 (FIG. 2) to determine a depth map for an area, such as the surface(s) 210 (FIG. 2) for example. The machine readable instructions and/or operations 1200 of FIG. 12 begin at block 1202, at which projection system 200 projects a pattern on the surface(s) 210 by emitting light through the optic piece 204 which, in turn, projects a pattern onto the surface(s) 210. In some examples, the pattern includes multiple ones of a semi-random grid or arrangement of spots on the surface(s) 210. Alternatively, in some examples, the pattern includes multiple ones of a uniform. grid or arrangement of spots on the surface(s) 210. In some examples, the projection system 200 projects the pattern to have a field of view that corresponds with a field of view of the first camera 212 and the second camera 214 (FIG. 2).

At block 1204, the example projection system 200 captures a first image of the surface(s) 210. For example, the first camera 212 can capture the first image, which includes the pattern projected by the optical piece 204 onto the surface(s) 210.

At block 1206, the projection system 200 of the illustrated example captures a second image of the surfaces) 210. For example, the second camera 214 can capture the second image, which includes the pattern projected by the optical piece 204 onto the surface(s) 210.

At block 1208, the projection system 200 identifies a point in the pattern captured in the first and second images. For example, the triangulation computing circuitry 216 (FIG. 2) can identify the point in the pattern based on the first and second images.

At block 1210, the projection system 200 computes a depth of the point. For example, the triangulation computing circuitry 216 can determine the depth of the point using triangulation. Specifically, the triangulation circuitry 216 can utilize the known locations of the first and second cameras 212, 214 to compute a 3-D coordinate of the point via. triangulation. In turn, the triangulation circuitry 216 can assign the computed 3-D coordinate to the point in the images.

At block 1212, the projection system 200 generates a depth map indicative of 3-D coordinates along the surface(s) 210. For example, the depth map generating circuitry 218 can update a portion of the depth map based on the determined 3-D coordinates of the point in the images.

At block 1214, the projection system 200 determines whether the depth map is complete. For example, the depth map generating circuitry 218 can determine whether 3-D coordinates have been computed for respective areas of the surface(s) 210. In response to the depth map generating circuitry 218 determining a portion (e.g., a threshold portion) of the surface(s) in the images is not assigned a. 3-D coordinate, the operations 1200 return to block 1208, Otherwise, in response to the depth map being complete, the operations 1200 terminate.

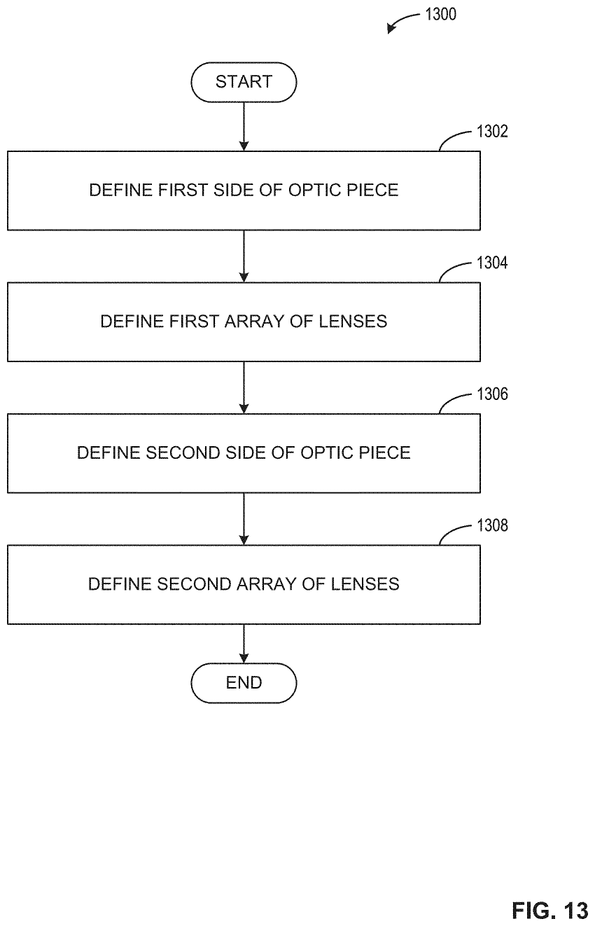

FIG. 13 is a flowchart representative of an example method 1300 to manufacture the optic piece 204 of FIG. 2. The example method 1300 of FIG. 13 begins at block 1302, at which the first side 206 of the optic piece 204 is defined. For example, the first side 206 of the optic piece 204 can be defined and/or formed via molding.

At block 1304, the first array of lenses 302 (FIGS, 3A and 5) is defined on the first side 206 of the optic piece 204. For example, the first array of lenses 302 of FIGS. 3A and 5 can be defined and/or formed on the first side 206 of the optic piece 204 via molding.

At block 1304, the second side 208 of the optic piece 204 is defined. For example, the second side 208 of the optic piece 204 can be defined via molding. In some examples, the second side 208 of the optic piece 204 is planar. In some other examples, the second side 208 of the optic piece is curved.

At block 1308, the second array of lenses 308. 402 (FIGS. 3B or 4A-4C) are defined on the second side 208 of the optic piece 204. In sonic examples, a first implementation of the second array of lenses 308, as shown in FIG. 3B, is defined (e.g., molded) molded onto the second side 208 when the second side 208 is planar. In such examples, the lenses 310 in the second array of lenses 308 are defined to include different focal lengths based on respective locations of the lenses 310 in the array 308. In some examples, a second implementation of the second array of lenses 402, as shown in FIGS. 4A-4C, is molded onto the second side 208 when the second side 208 is curved. In such examples, the lenses 404 in the second array of lenses 402 include a same curvature and focal length. In some examples, the geometries of the optic piece 204 are formed in a single molding (e.g., injection molding process).

FIG. 14 is a block diagram of an example processor platform 1400 structured to execute and/or instantiate the machine readable instructions and/or operations of FIG. 12. to implement the projection system 200 of FIG. 2. The processor platform 1400 can be, for example, a server, a personal computer, a workstation, a self-learning machine (e.g., a neural network), a mobile device (e.g, a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc. or other wearable device, or any other type of computing device.

The processor platform 1400 of the illustrated example includes processor circuitry 1412. The processor circuitry 1412 of the illustrated example is hardware. For example, the processor circuitry 1412 can be implemented by one or more integrated circuits, logic circuits, FPGAs microprocessors, CPUs, CPUs, DSPs, and/or microcontrollers from any desired family or manufacturer. The processor circuitry 1412 may be implemented by one or more semiconductor based (e.g., silicon based) devices. In this example, the processor circuitry 1412 implements the triangulation computing circuitry 216 and the depth map generating circuitry 218.

The processor circuitry 1412 of the illustrated example includes a local memory 1413 (e.g., a cache, registers, etc.). The processor circuitry 1412 of the illustrated example is in communication with a main memory including a volatile memory 1414 and a non-volatile memory 1416 by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417.

The processor platform 1400 of the illustrated example also includes interface circuitry 1420. The interface circuitry 1420 may he implemented by hardware in accordance with any type of interface standard, such as an Ethernet interface, a universal serial bus (USB) interface, a Bluetooth® interface, a near field communication (NEC) interface, a PC1 interface, and/or a PCIe interface.

In the illustrated example, one or more input devices 1422 are connected to the interface circuitry 1420. The input device(s) 1422 permit(s) user to enter data and/or commands into the processor circuitry 1412. The input device(s) 1422 can be implemented by, for example, an audio sensor, a microphone, a camera (still or video), a keyboard, a button, a mouse, a touchscreen, a track-pad, a trackball, an isopoint device, and/or a voice recognition system. In this example, the input device(s) 1422 implement the first camera 212 and the second camera 214.

One or more output devices 1424 are also connected to the interface circuitry 1420 of the illustrated example. The output devices 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1400 of the illustrated example also includes one or more mass storage devices 1428 to store software and/or data. Examples of such mass storage devices 1428 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1432, which may be implemented by the machine readable instructions of FIG. 12, may be stored in the mass storage device 1428, in the volatile memory 1414, in the non-volatile memory 1416, and/or on a removable non-transitory computer readable storage medium such as a CD or DVD.

FIG. 15 is a block diagram of an example implementation of the processor circuitry 1412 of FIG. 14. In this example, the processor circuitry 1412 of FIG. 14 is implemented by a microprocessor 1500. For example, the microprocessor 1500 may implement multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowchart 1200 of FIG. 12.

The cores 1502 may communicate by an example bus 1504. In some examples, the bus 1504 may implement a communication bus to effectuate communication associated with one(s) of the cores 1502. For example, the bus 1504 may implement at least one of an Inter-Integrated Circuit (I2C) bus, a Serial Peripheral Interface (SPI) bus, a PCI bus, or a PCIe bus, Additionally or alternatively, the bus 1504 may implement any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2) cache)) for high-speed access to data and/or instructions. Data and/or instructions may be transferred (e.g., shared) by writing to and/or reading from the shared memory 1510. The local memory 1520 of each of the cores 1502 and the shared memory 15110 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuity 1514, arithmetic and logic (AL) circuitry (sometimes referred to as an ALU) 1516, a plurality of registers 1518, the Li cache 1520, and an example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating point operations. In yet other examples, the AL circuitry 1516 may include first AL circuitry that performs integer based operations and second AL circuitry that performs floating point operations. In some examples, the AL circuitry 1516 may be referred to as an Arithmetic Logic Unit (ALU). The registers 1518 are semiconductor-based structures to store data and/or instructions such as results of one or more of the operations performed by the AL circuitry 1516 of the corresponding core 1502. For example, the registers 1518 may include vector register(s), SIMD register(s), general purpose register(s), flag register(s), segment register(s), machine specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure including distributed throughout the core 1502 to shorten access time. The bus 1520 may implement at least one of an I2C bus, a SPI bus, a PCI bus, or a PCIe bus

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator, Accelerators may be on-board the processor circuitry, in the same chip package as the processor circuitry and/or in one or more separate packages from the processor circuitry.

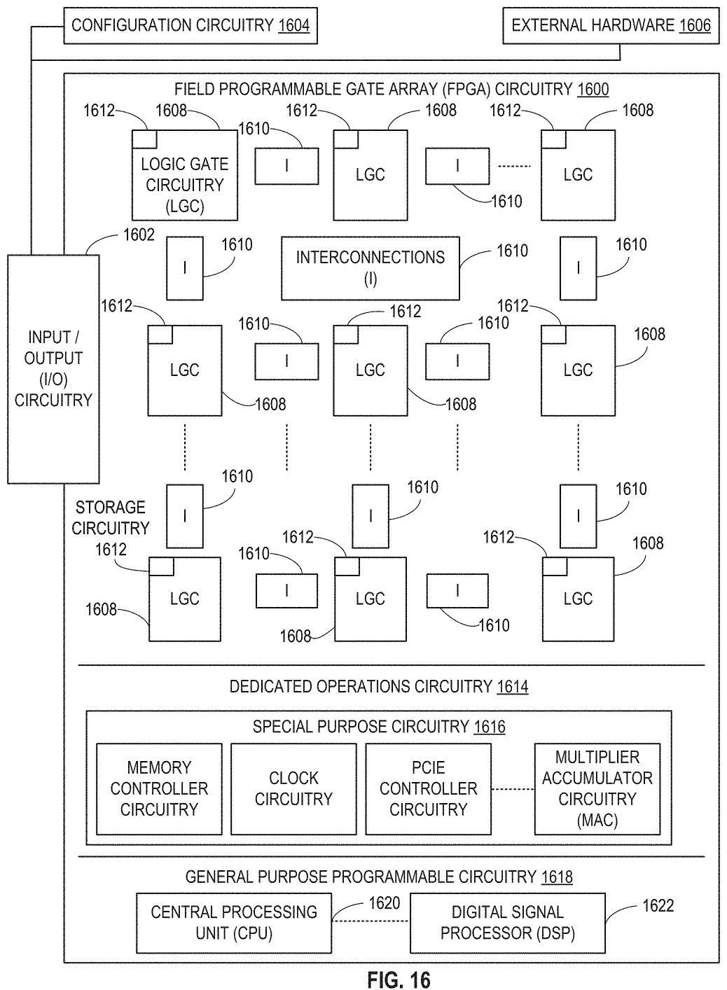

FIG. 16 is a block diagram of another example implementation of the processor circuitry 1412 of FIG. 14. In this example, the processor circuitry 1412 is implemented by FPGA circuitry 1600. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the machine readable instructions in hardware and, thus, can often execute the operations faster than they could be performed by a general purpose microprocessor executing the corresponding software.

More specifically, in contrast to the microprocessor 1500 of FIG. 15 described above (which is a general purpose device that may be programmed to execute some or all of the machine readable instructions represented by the flowchart of FIG. 12 but whose interconnections and logic circuitry are fixed once fabricated), the FPGA circuitry 1600 of the example of FIG. 16 includes interconnections and logic circuitry that may be configured and/or interconnected in different ways after fabrication to instantiate, for example, some or all of the machine readable instructions represented by the flowchart of FIG. 12. In particular, the FPGA 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the software represented by the flowchart of FIG. 12. As such, the FPGA circuitry 1600 may be structured to effectively instantiate some or all of the machine readable instructions of the flowchart of FIG. 12 as dedicated logic circuits to perform the operations corresponding to those software instructions in a dedicated manner analogous to an ASIC. Therefore, the FPGA circuitry 1600 may perform the operations corresponding to the some or all of the machine readable instructions 1200 of FIG. 12 faster than the general purpose microprocessor can execute the same.

In the example of FIG. 16, the FPGA circuitry 1600 is structured to be programmed (and/or reprogrammed one or more times) by an end user by a hardware description language (HDL) such as Verilog. The FPGA circuitry 1600 of FIG. 16, includes example input/output (I/O) circuitry 1602 to obtain and/or output data to/from example configuration circuitry 1604 and/or external hardware (e.g., external hardware circuitry) 1606. For example, the configuration circuitry 1604 may implement interface circuitry that may obtain machine readable instructions to configure the FPGA circuitry 1600, or portion(s) thereof. In some such examples, the configuration circuitry 1604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1606 may implement the microprocessor 1500 of FIG. 15. The FPGA circuitry 1600 also includes an array of example logic gate circuitry 1608, a plurality of example configurable interconnections 1610, and example storage circuitry 1612. The logic gate circuitry 1608 and interconnections 1610 are configurable to instantiate one or more operations that may correspond to at least some of the machine readable instructions 1200 of FIG. 12 and/or other desired operations. The logic gate circuitry 1608 shown in FIG. 16 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits.

Electrically controllable switches (e.g., transistors) are present within each of the logic gate circuitry 1608 to enable configuration of the electrical structures and/or the logic gates to form circuits to perform desired operations. The logic gate circuitry 1608 may include other electrical structures such as look-up tables (LUTs), registers (e.g., flip-flops or latches), multiplexers, etc.

The interconnections 1610 of the illustrated example are conductive pathways, traces, vias, or the like that may include electrically controllable switches (e.g.. transistors) whose state can be changed by programming (e.g., using an HDL instruction language) to activate or deactivate one or more connections between one or more of the logic gate circuitry 1608 to program desired logic circuits.

The storage circuitry 612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example Dedicated Operations Circuitry 1614. In this example, the Dedicated Operations Circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the processor circuitry 1412 of FIG. 14, many other approaches are contemplated. For example, as mentioned above, modern FPGA circuitry may include an on-board CPU, such as one or more of the example CPU 1620 of FIG. 16. Therefore, the processor circuitry 1412 of FIG. 14 may additionally be implemented by combining the example microprocessor 1500 of FIG. 15 and the example FPGA circuitry 1600 of FIG. 16. In some such hybrid examples, a first portion of the machine readable instructions 1200 represented by the flowchart of FIG. 12 may be executed by one or more of the cores 1502 of FIG. 15 and a second portion of the machine readable instructions 1200 represented by the flowchart of FIG. 12 may be executed by the FPGA circuitry 1600 of FIG. 16.

In some examples, the processor circuitry 1412 of FIG. 14 may be in one or more packages. For example, the processor circuitry 1500 of FIG. 15 and/or the FPGA circuitry 1600 of FIG. 16 may be in one or more packages. In some examples, an XPU may be implemented by the processor circuitry 1412 of FIG. 14, which may be in one or more packages. For example, the XPU may include a CPU in one package, a DSP in another package, a GPU in yet another package, and an FPGA in still yet another package.

From the foregoing, it will be appreciated that example systems, methods, apparatus, and articles of manufacture have been disclosed that project light patterns with improved stability to minimize or otherwise reduce spatial or temporal noise in depth maps. Examples disclosed herein increase manufacturing and/or assembly tolerance ranges of an alignment associated with an example optic piece relative to one or more light sources. Examples disclosed herein combine light from multiple coherent sources to obtain an incoherent combination of waves that minimizes or otherwise reduces laser speckle.

Optical pieces having integrated lens arrays are disclosed herein. Further examples and combinations thereof include the following:

Example 1 includes an optic piece for use with a projection system, the optic piece comprising a body extending between a first side of the body and a second side of the body that is opposite the first side, the body at least partially transparent, a first array of lenses on the first side of the body, ones of the first array of lenses having a respective first surface area, and a second array of lenses on the second side of the body, ones of the second array of lenses having a respective second surface area that is larger than the first surface area.

Example 2 includes the optic piece of example 1, wherein the first side of the body includes a planar surface, the first array of lenses protruding from the first side along a direction away from the second side.

Example 3 includes the optic piece of example 2, wherein the planar surface is a first planar surface, the second side including a second planar surface from which the second array of lenses protrudes.

Example 4 includes the optic piece of example 3, wherein the second array of lenses includes a first lens and a second lens, the first lens having a first focal length, the second lens having a second focal length different from the first focal length.

Example 5 includes the optic piece of example 1, wherein the second side includes a curved surface.

Example 6 includes the optic piece of example 5, wherein ones of the second array of lenses include at least one of a same curvature or a same focal length.

Example 7 includes the optic piece of example 1, wherein ones of the first array of lenses are contiguous and ones of the second array of lenses are contiguous.

Example 8 includes the optic piece of example 1, wherein the optic piece is at least partially composed of polycarbonate.

Example 9 includes the optic piece of example 1, wherein the optic piece is formed via at least one of molding, three dimensional printing, electroforming, or diamond turning.

Example 10 includes the optical piece of example 1, wherein the first array includes a grid for which ones of the first array of lenses are uniformly spaced along at least one dimension.

Example 11 includes the optical piece of example 1, wherein the first array includes a grid for which ones of the first array of lenses are randomly spaced along at least one dimension.

Example 12 includes a system comprising a light source to emit light, and an optical piece to project the light from the light source onto a surface, the optical piece including a first array of lenses on a first side of the optical piece, ones of the first array of lenses having a first surface area, and a second array of lenses on a second side of the optical piece that is opposite the first side, ones of the second array of lenses having a second surface area greater than the first surface area.

Example 13 includes the system of example 12, wherein the light source includes a virtual cavity surface emitting laser.

Example 14 includes the system of example 12, wherein the light source includes a light emitting diode.

Example 15 includes the system of example 12, wherein the light source is a first light source, and further including a second light source, the first array of lenses including a first lens to receive light from the first light source and the second light source.

Example 16 includes the system of example 12, wherein the second array of lenses includes a first lens and a second lens, the first lens to project a first pattern at a first location, the second lens to project the first pattern at a second location different from the first location.

Example 17 includes the system of example 16, wherein the first pattern is based on a grid defined by the first array of lenses.

Example 18 includes the system of example 12, wherein a portion of the first array of lenses receives the light emitted from the light source.

Example 19 includes the system of example 12, wherein the light source is separated from the optical piece by a distance greater than 10 micrometers.

Example 20 includes an apparatus comprising means for emitting light, and means for refracting the light emitted by the means for emitting, the means for refracting to produce a light pattern in response to receiving the light on a first side of the means for refracting, the means for refracting to project multiple ones of the light pattern on a second side of the means for refracting opposite the first side.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An optic piece for use with a projection system, the optic piece comprising:
a body extending between a first side of the body and a second side of the body that is opposite the first side, the body at least partially transparent;
a first array of lenses on the first side of the body, ones of the first array of lenses having a respective first surface area; and
a second array of lenses on the second side of the body, ones of the second array of lenses having a respective second surface area that is larger than the first surface area.

2. The optic piece of claim 1, wherein the first side of the body includes a planar surface, the first array of lenses protruding from the first side along a direction away from the second side.

3. The optic piece of claim 2, wherein the planar surface is a first planar surface, the second side including a second planar surface from which the second array of lenses protrudes.

4. The optic piece of claim 3, wherein the second array of lenses includes a first lens and a second lens, the first lens having a first focal length, the second lens having a second focal length different from the first focal length.

5. The optic piece of claim 1, wherein the second side includes a curved surface.

6. The optic piece of claim 5, wherein ones of the second array of lenses include at least one of a same curvature or a same focal length.

7. The optic piece of claim 1, wherein ones of the first array of lenses are contiguous and ones of the second array of lenses are contiguous.

8. The optic piece of claim 1, wherein the optic piece is at least partially composed of polycarbonate.

9. The optic piece of claim 1, wherein the optic piece is formed via at least one of molding, three dimensional printing, electroforming, or diamond turning.

10. The optical piece of claim 1, wherein the first array includes a grid for which ones of the first array of lenses are uniformly spaced along at least one dimension.

11. The optical piece of claim 1, wherein the first array includes a grid for which ones of the first array of lenses are randomly spaced along at least one dimension.

12. A system comprising:
a light source to emit light; and
an optical piece to project the light from the light source onto a surface, the optical piece including:
a first array of lenses on a first side of the optical piece, ones of the first array offenses having a first surface area; and
a second array of lenses on a second side of the optical piece that is opposite the first side, ones of the second array of lenses having a second surface area greater than the first surface area.

13. The system of claim 12, wherein the light source includes a virtual cavity surface emitting laser.

14. The system of claim 12, wherein the light source includes a light emitting diode.

15. The system of claim 12, wherein the light source is a first light source, and further including a second light source, the first array of lenses including a first lens to receive light from the first light source and the second light source.

16. The system of claim 12, wherein the second array of lenses includes a first lens and a second lens, the first lens to project a first pattern at a first location, the second lens to project the first pattern at a second location different from the first location.

17. The system of claim 16, wherein the first pattern is based on a grid defined by the first array of lenses.

18. The system of claim 12, wherein a portion of the first array of lenses receives the light emitted from the light source.

19. The system of claim 12, wherein the light source is separated from the optical piece by a distance greater than 10 micrometers.

20. An apparatus comprising:
means for emitting light; and
means for refracting the light emitted by the means for emitting, the means for refracting to produce a light pattern in response to receiving the light on a first side of the means for refracting, the means for refracting to project multiple ones of the light pattern on a second side of the means for refracting opposite the first side.
